(19) United States
(12) Patent Application Publication
(10) Pub. No.: US 2026/0138277 A1
(43) Pub. Date: May 21, 2026

(54) DEVICE FOR LOGISTIC AUTOMATION WITH COLLISION AVOIDANCE FUNCTION AND LOGISTIC AUTOMATION METHOD USING THE SAME

(71) Applicant: BRILS Co., Ltd., Incheon (KR)

(72) Inventor: Jin JEON, Incheon (KR)

(73) Assignee: BRILS Co., Ltd., Incheon (KR)

(21) Appl. No.: 19/219,264

(22) Filed: May 27, 2025

(30) Foreign Application Priority Data
Nov. 20, 2024 (KR) 10-2024-0166048

(51) Int. Cl. B25J 9/16; G03B 21/00

(52) U.S. Cl. CPC B25J 9/1676; B25J 9/1666; B25J 9/1671; B25J 9/1687; G03B 21/00

(57) ABSTRACT

The present invention proposes a logistics automation device with a collision avoidance function that can prevent collisions between a robot and a worker during the implementation of logistics automation. The device may include a gripper robot for gripping objects, a projector that displays a monitoring area with collision risks based on the movement of the gripper robot, and a controller that variably sets the monitoring area according to the movement of the gripper robot, and controls the operation of the gripper robot to ensure that the set monitoring area is displayed through the projector.

### CROSS-REFERENCE TO RELATED APPLICATIONS AND CLAIM OF PRIORITY

The present application claims priority to Korean Patent Application No. 10-2024-0166048, filed on Nov. 20, 2024, the entire contents of which are incorporated herein for all purposes by this reference.

### TECHNICAL FIELD

The present invention relates to an automation device. More specifically, it pertains to a logistics automation device with a collision avoidance function that can prevent collisions between a robot and a worker during the implementation of logistics automation, as well as a logistics automation method using the same.

### BACKGROUND

A logistics automation system refers to a system that automates processes such as packaging, sorting, loading, and transportation of goods, aimed at improving logistics efficiency through the integration of Internet of Things (IoT) technology, autonomous driving technology, and artificial intelligence (AI) technologies such as environmental, situational awareness, and task planning. This system is commonly applied in logistics centers, factories, and similar environments.

Meanwhile, a collaborative robot refers to a robot that collaborates with humans in a shared workspace, acting as a partner. Due to its relatively low cost and the ability to be quickly applied across various industrial fields, it has recently gained significant attention. Furthermore, collaborative robots offer advantages over traditional industrial robots, such as ease of operation and flexibility in reconfiguring processes, making them adaptable to various tasks and operations. Unlike industrial robots that typically perform repetitive tasks, collaborative robots are evolving into fusion systems integrating IT (Information & Communication Technology) technologies such as artificial intelligence, human interfaces, and ubiquitous networks.

To implement collaborative work between humans and robots using collaborative robots, three key characteristics must be met: safety, coexistence, and collaboration. In particular, safety refers to the ability to avoid collisions with the worker or the ability of the robot to detect a collision in the event of an unavoidable encounter and respond to mitigate the associated risk.

Recently, regulations have required the installation of fences or responsive protective devices in the work area to ensure safety in human-robot collaborative operations. However, such measures alone have proven insufficient to fully ensure the safety of workers.

### SUMMARY

One object of the present invention is to provide a logistics automation device with a collision avoidance function that can prevent collisions between a robot and a worker during the implementation of logistics automation.

Another object of the present invention is to provide a logistics automation method with a collision avoidance function that can prevent collisions between a robot and a worker during the implementation of logistics automation.

The technical problems of the present invention are not limited to those mentioned above, and other technical problems not explicitly mentioned will be clearly understood by those skilled in the art from the following description.

To achieve the technical problems described above, the present invention proposes a logistics automation device with a collision avoidance function that can prevent collisions between a robot and a worker during the implementation of logistics automation. The device may include a gripper robot for gripping objects, a projector that marks a monitoring area where there is a collision risk based on the movement of the gripper robot, and a controller that adjusts the monitoring area in real-time based on the movement of the gripper robot and controls the operation of the gripper robot to ensure that the monitoring area is displayed through the projector.

The projector is installed on the gripper robot, moves with the gripper robot, and displays the set monitoring area on the ground.

The controller ensures that the position of the monitoring area output on the ground by the projector does not change, by variably controlling the light emitted from the projector according to the movement of the gripper robot.

The controller establishes a work plan for the gripper robot, estimates the movement range of the gripper robot according to the established work plan, and sets the monitoring area variably for each task based on the estimated movement range.

The controller simulates the movement of the gripper robot based on the established work plan, generates a path map by overlapping the movement paths of the gripper robot, and controls the setting of the monitoring area to correspond with the generated path map, ensuring that the monitoring area is displayed through the projector.

The controller divides the path map into multiple unit areas of preset size, counts the number of times the gripper robot moves within each of the multiple unit areas, and assigns a risk level to each of the unit areas based on the counted number of movements.

The controller sets the monitoring area to correspond with the generated path map, and outputs light with different colors from the projector for each of the multiple unit areas according to the assigned risk levels.

The controller identifies the stacking location of the object gripped by the gripper robot based on the established work plan and displays the expected stacking area in real-time at the identified stacking location through the projector.

The controller records the established work plan as a timestamp and, based on the recorded timestamp, divides the work plan into preset sections. The controller then variably sets the monitoring area based on the estimated movement range of the gripper robot for each of the divided sections.

The present invention proposes a logistics automation method with a collision avoidance function that can prevent collisions between a robot and a worker during the implementation of logistics automation. The method includes the following steps: estimating the movement of a gripper robot for gripping objects by a management device, setting a monitoring area with collision risks in a variable manner according to the movement of the gripper robot by the management device, and controlling the operation of the gripper robot by the management device so that the set monitoring area is displayed through a projector.

Specific details of other embodiments are included in the detailed description and the drawings.

### BRIEF DESCRIPTION OF THE DRAWINGS

FIG. 1 is a block diagram showing the configuration of a logistics automation system according to an embodiment of the disclosure.

FIG. 2 is an illustrative diagram for explaining a logistics automation device according to an embodiment of the disclosure.

FIG. 3 is an illustrative diagram for explaining a logistics automation device according to another embodiment of the disclosure.

FIG. 4 is a logical block diagram of a management device according to an embodiment of the disclosure.

FIGS. 5 to 8 are illustrative diagrams for explaining a collision avoidance function according to an embodiment of the disclosure.

FIGS. 9 and 10 are illustrative diagrams for explaining a collaborative function according to an embodiment of the disclosure.

FIG. 11 is a hardware block diagram of a management device according to an embodiment of the disclosure.

FIG. 12 is a flowchart for explaining a logistics automation method according to an embodiment of the disclosure.

### DETAILED DESCRIPTION

The technical terms used in this specification are employed merely to describe specific embodiments and are not intended to limit the present invention. Furthermore, unless otherwise defined in this specification, the technical terms used herein should be interpreted in their commonly understood meaning by those skilled in the art to which the invention pertains, and should not be interpreted in an unduly broad or unduly narrow sense. Additionally, when a technical term used in this specification does not accurately express the spirit of the invention, it should be understood as being replaced by a term that can be correctly understood by those skilled in the art. Also, general terms used in the present invention should be interpreted according to their definition in the art or in the context of the specification, and should not be interpreted in an unduly restricted sense.

Furthermore, the singular expressions used in this specification are intended to include the plural forms unless the context clearly indicates otherwise. In this application, terms such as “comprise” or “have” should not be interpreted as necessarily including all of the multiple components or steps described in the specification. Some of the components or steps may not be included, or additional components or steps may be included.

Additionally, terms including ordinals such as “first,” “second,” and the like, are used to describe various components, but the components are not limited by these terms. These terms are only used for the purpose of distinguishing one component from another. For example, without departing from the scope of the present invention, a “first” component may be named as a “second” component, and similarly, a “second” component may be named as a “first” component.

When an element is referred to as being “connected to” or “coupled to” another element, it may be directly connected or coupled to the other element, or there may be intervening components. In contrast, when an element is referred to as being “directly connected to” or “directly coupled to” another element, it should be understood that no intervening components are present.

Hereinafter, preferred embodiments of the present invention will be described in detail with reference to the accompanying drawings. Identical or similar components are assigned the same reference numbers regardless of the drawings, and redundant descriptions of these components will be omitted. Additionally, when describing the present invention, detailed descriptions of related known technologies will be omitted if it is determined that such descriptions may obscure the gist of the invention. Furthermore, the accompanying drawings are provided only to facilitate understanding of the spirit of the present invention, and it should be noted that the spirit of the invention should not be construed as being limited by the drawings. The scope of the invention should be interpreted to extend to all modifications, equivalents, and substitutions beyond the accompanying drawings.

Meanwhile, to implement collaborative work between humans and robots using collaborative robots, three key characteristics must be met: safety, coexistence, and collaboration. In particular, safety refers to the ability to avoid collisions with the worker, or the ability of the robot to detect a collision in the event of an unavoidable encounter and respond to mitigate the associated risks.

Recently, regulations have required the installation of fences or responsive protective devices in the work area to ensure safety in human-robot collaborative operations. However, such measures alone have proven insufficient to fully ensure the safety of workers.

To overcome these limitations, the present invention aims to propose various means that can prevent collisions between a robot and a worker during the implementation of logistics automation.

According to embodiments of the present invention, by variably setting the monitoring area based on the movement of the gripper robot and controlling the operation of the gripper robot so that the set monitoring area is displayed through a projector, the worker can intuitively recognize the danger area during the collaborative operation with the gripper robot.

The effects of the present invention are not limited to those mentioned above, and other effects not explicitly mentioned will be clearly understood by those skilled in the art from the descriptions of the claims.

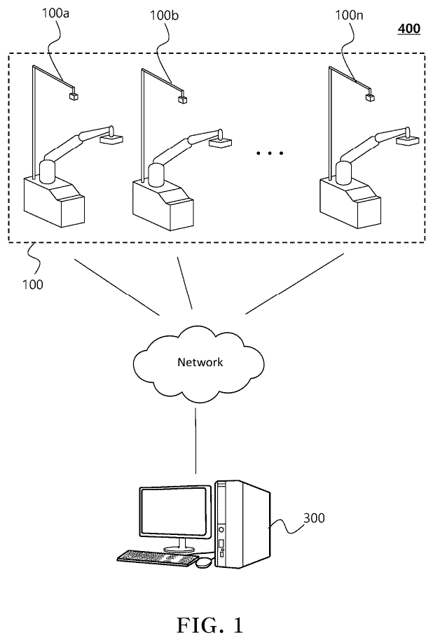

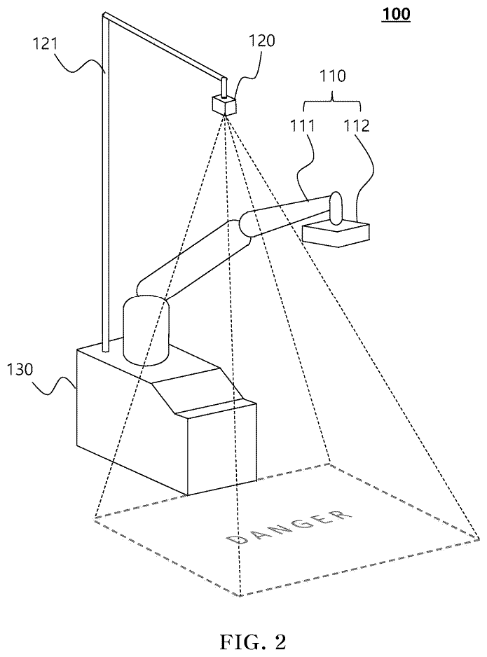

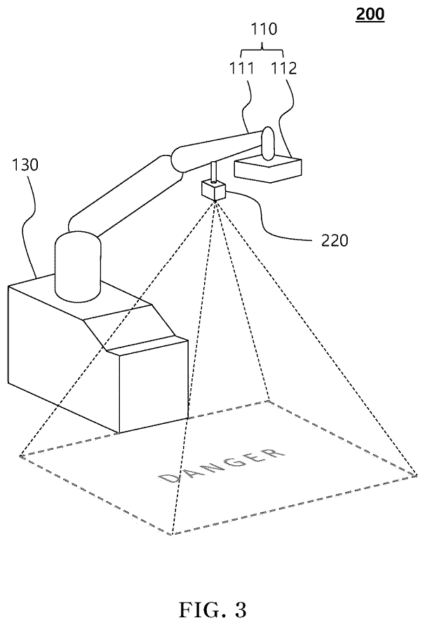

FIG. 1 is a block diagram showing the configuration of a logistics automation system according to an embodiment of the disclosure, FIG. 2 is an illustrative diagram for explaining a logistics automation device according to an embodiment of the disclosure, and FIG. 3 is an illustrative diagram for explaining a logistics automation device according to another embodiment of the disclosure.

Referring to FIGS. 1 to 3, a logistics automation system (400) according to an embodiment of the disclosure may include at least one logistics automation device (100a, 100b, . . . , 100n; 100) and a management device (300).

As such, the components of the logistics automation system (400) according to an embodiment of the disclosure represent functionally distinct elements, and therefore, two or more components may be implemented together in an integrated manner in a physical environment, or a single component may be implemented as separate physical elements in the actual environment.

Describing each component, the logistics automation device (100) may be a device that collaborates with a worker to grip an object and either load it onto a pallet or unload an object from a pallet. Here, the pallet may be a cargo loading platform designed to facilitate handling and unloading tasks in logistics transportation and product storage.

In one embodiment of the present invention, the logistics automation device (100) is described as a device for performing palletizing or depalletizing; however, it is not limited to this, and various types of devices capable of transporting objects to a specific location may be applied.

Such a logistics automation device (100) may include a gripper robot (110), a projector (120), and a controller (130).

The gripper robot (110) may be a device that grips an object and either loads it onto a pallet or unloads an object from a pallet. Such a gripper robot (110) may include a robot arm (111) and a gripper unit (112).

For example, the robot arm (111) may be composed of multiple links, at least one joint connecting the links, and a gripper bracket attached to the end of the final link in the series of links.

The gripper unit (112) is installed at the end of the robot arm (111) and is capable of gripping an object or releasing the grip on a gripped object to place it down. In one embodiment of the present invention, the gripper unit (112) may be a vacuum gripper, which is capable of gripping objects in a standardized box form. However, it is not limited to this, and the gripper unit (112) may include various types of grippers such as a finger gripper, a soft gripper, or a gecko gripper.

The projector (120) may project light onto the ground to display a monitoring area with collision risks based on the movement of the gripper robot (110). Here, the monitoring area may correspond to an area set on the ground in relation to the movement range of the gripper robot (110).

For example, the projector (120) may be a digital light processing (DLP) projector, a liquid crystal display (LCD) projector, a cathode ray tube (CRT) projector, a laser projector, or other types of projectors.

As shown in FIG. 2, the logistics automation device (100) according to an embodiment of the present invention may have the projector (120) fixedly installed by a mounting unit (121) that is separately installed from the gripper robot (110). That is, the projector (120) may be configured to project light toward the ground from the upper portion of the gripper robot (110) through a mounting unit (121) that extends from the ground to the upper part of the gripper robot (110).

As shown in FIG. 3, the logistics automation device (200) according to another embodiment of the present invention may have the projector (220) installed on the gripper robot (110), moving with the gripper robot (110) and projecting light toward the ground. Specifically, the projector (220) may be installed at the end of the robot arm (111) adjacent to the gripper unit (112) of the gripper robot (110). In this case, the projector (220) may be attached to the underside of the robot arm (111). This configuration allows the projector (220) to project light onto the ground without being obstructed by the gripper robot (110).

The controller (130) may control the movement of the gripper robot (110). In this process, the controller (130) may variably set the monitoring area according to the movement of the gripper robot (110) and control the operation of the gripper robot (110) so that the set monitoring area is displayed through the projector (120).

Meanwhile, the controller (130) may be configured to perform some or all of the functions of the management device (300), which will be described later. Accordingly, the detailed description of the controller (130) is replaced by the description of the management device (300) below.

In a subsequent configuration, the management device (300) may control and manage at least one logistics automation device (100a, 100b, . . . , 100n; 100).

Specifically, the management device (300) may control the movement of the gripper robot (110). In this case, the management device (300) may variably set the monitoring area according to the movement of the gripper robot (110) and control the operation of the gripper robot (110) so that the set monitoring area is displayed through the projector (120).

The specific configuration of the management device (300) will be described later with reference to the following drawings.

A management device (300) with such features may be any device capable of transmitting and receiving data with at least one logistics automation device (100) and performing computations based on the transmitted and received data. For example, the management device (300) may be any fixed computing device, such as a desktop, workstation, or server, but is not limited to these.

Hereinafter, the management device (300) according to an embodiment of the present invention will be described in more detail.

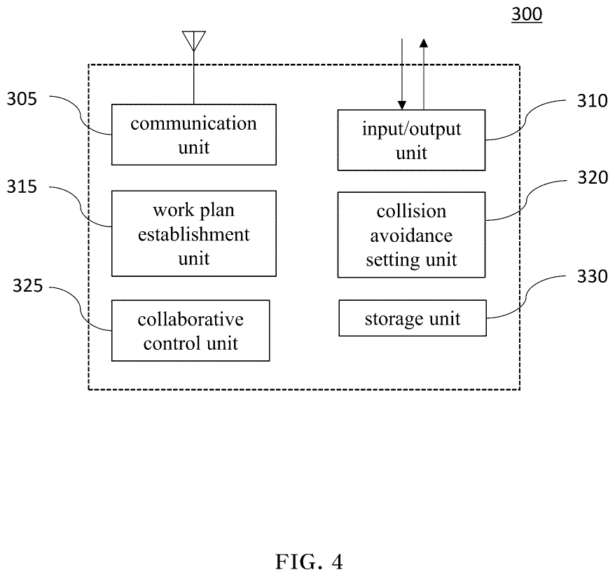

FIG. 4 is a logical block diagram of a management device according to an embodiment of the present invention.

Referring to FIG. 4, the management device (300) according to an embodiment of the present invention may include a communication unit (305), an input/output unit (310), a work plan establishment unit (315), a collision avoidance setting unit (320), a collaborative control unit (325), and a storage unit (330).

The components of the management device (300) according to an embodiment of the present invention represent functionally distinct elements, and therefore, two or more components may be implemented together in an integrated manner in a physical environment, or a single component may be implemented as separate physical elements in the actual environment.

Describing each component, the communication unit (305) may transmit and receive data with at least one logistics automation device (100). Specifically, the communication unit (305) may transmit control signals to control the logistics automation device (100). In addition, the communication unit (305) may receive status information based on the control signals from the logistics automation device (100).

In a subsequent configuration, the input/output unit (310) may receive signals from the user through a user interface (UI) or output computation results externally. Specifically, the input/output unit (310) may receive signals to control the logistics automation device (100) or output status information of the logistics automation device (100).

In a subsequent configuration, the work plan establishment unit (315) may establish a work plan for the gripper robot (110).

Specifically, the work plan establishment unit (315) may establish a work plan for the gripper robot (110) to grip an object loaded onto a pallet and transfer it to a conveyor, or to load an object from the conveyor onto a pallet. Here, a task may be a sequence of steps to perform a specific mission.

For example, the work plan establishment unit (315) may determine the order or priority for processing objects loaded onto the pallet or decide the placement location of the objects to be loaded onto the pallet. Additionally, the work plan establishment unit (315) may set the movement path of the gripper robot (100) based on the priority or placement location. Furthermore, the work plan establishment unit (315) may control the operation of the gripper robot (110) according to the set movement path.

In a subsequent configuration, the collision avoidance setting unit (320) may variably set the monitoring area according to the movement of the gripper robot (110), which is controlled by the work plan establishment unit (315), and may control the operation of the gripper robot (110) so that the set monitoring area is displayed through the projector (120).

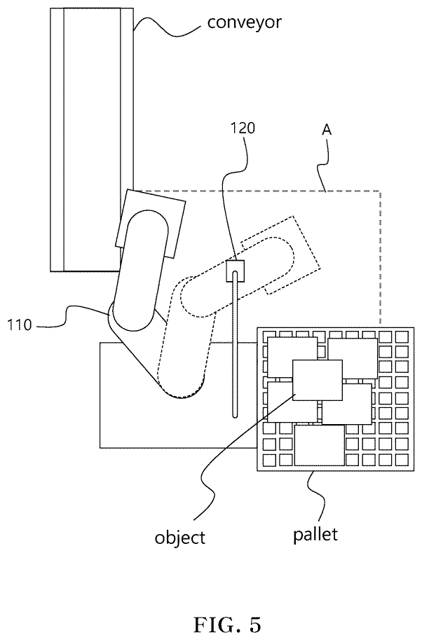

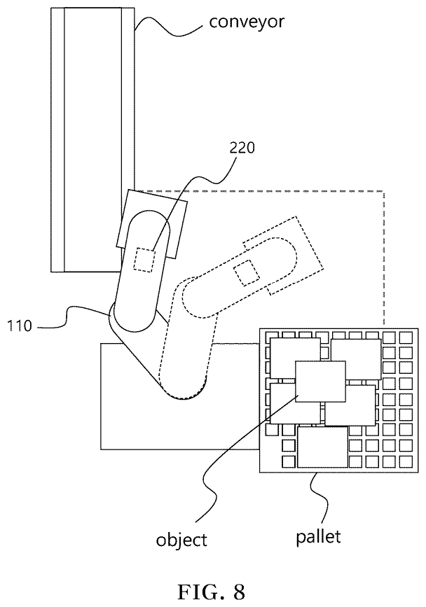

For a moment, referring to FIGS. 5 to 8, the collision avoidance function according to an embodiment of the present invention will be described in detail.

FIGS. 5 to 8 are illustrative diagrams for explaining the collision avoidance function according to an embodiment of the present invention.

The collision avoidance setting unit (320) may estimate the movement range of the gripper robot (110) based on the work plan established by the work plan establishment unit (315), and may variably set the monitoring area for each task based on the estimated movement range. Here, the movement range of the gripper robot (110) may refer to the range affected by the actions of the gripper robot (110).

Meanwhile, the aforementioned monitoring area may be set based on the movement range of the gripper robot (110). For example, the collision avoidance setting unit (320) may derive the coordinates of the gripper unit (120) located at the end of the gripper robot (110) by using the rotation angles of each joint of the gripper robot (110), and may estimate the movement range of the gripper robot (110) based on the derived coordinates of the gripper unit (120). That is, the collision avoidance setting unit (320) may set the monitoring area based on the x-axis and y-axis coordinates located at the outermost positions of the movement path of the gripper unit (110). Here, the monitoring area may be set to be wider than the movement range of the gripper robot (110) by a preset distance.

As shown in FIG. 5, the collision avoidance setting unit (320) may perform a task of transferring objects loaded on a pallet located to the right of the gripper robot (110) to a conveyor. In this case, the collision avoidance setting unit (320) may set a first monitoring area (A) corresponding to the movement range of the gripper robot (110). Then, the collision avoidance setting unit (320) may control the projector (120) located above the gripper robot (110) to output the first monitoring area (A) onto the ground.

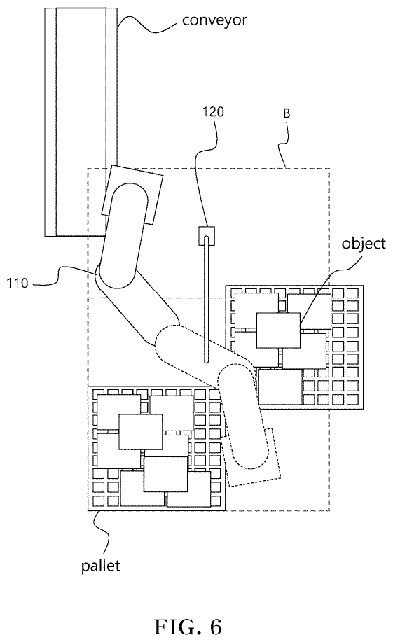

Alternatively, as shown in FIG. 6, the collision avoidance setting unit (320) may perform a task of transferring objects loaded on a pallet located to the right and rear of the gripper robot (110) to a conveyor. Since the movement range of the gripper robot (110) is wider in this scenario, the second monitoring area (B) may be set to be larger than the first monitoring area (A). Then, the collision avoidance setting unit (320) may control the projector (120) located above the gripper robot (110) to output the first monitoring area (A) onto the ground.

Meanwhile, as shown in FIGS. 5 and 6, the first monitoring area (A) and the second monitoring area (B) are depicted as rectangular areas based on the movement range of the gripper robot (110); however, they are not limited to this shape and may be irregularly set according to the movement range of the gripper robot (110). For example, the collision avoidance setting unit (320) may set the monitoring area based on the movement range of the gripper robot (110), while considering the shape of the gripper robot (110) when configuring the monitoring area.

In another embodiment, the collision avoidance setting unit (320) may simulate the movement of the gripper robot (110) based on the established work plan. That is, the collision avoidance setting unit (320) may generate a virtual robot corresponding to the gripper robot (110) in a virtual space and simulate the movement of the gripper robot (110). Then, the collision avoidance setting unit (320) may generate a path map by overlapping the movement paths of the gripper robot (110) through simulation. Here, the path map may be an image displaying the areas where the gripper robot (110) was located. The collision avoidance setting unit (320) may set the monitoring area based on the edge of the area corresponding to the gripper robot (110) on the path map. Additionally, the collision avoidance setting unit (320) may control the projector (120) located above the gripper robot (110) to output the monitoring area onto the ground.

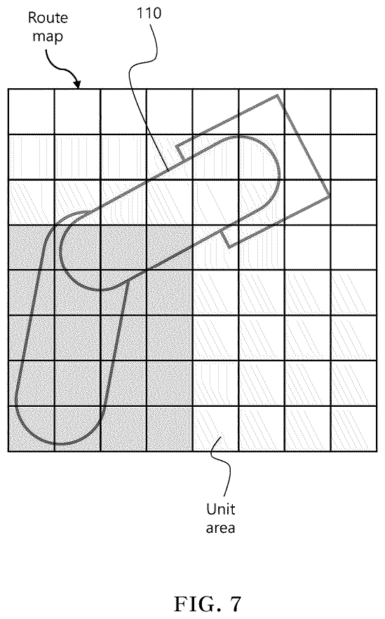

In another embodiment, the collision avoidance setting unit (320) may divide the previously generated path map into multiple unit areas of a preset size. That is, as shown in FIG. 7, the collision avoidance setting unit (320) may generate a route map corresponding to the movement range of the gripper robot (110) and divide the generated route map into multiple unit areas. For convenience in the description, the path map is depicted as a square, but it is not limited to this and may be formed in various shapes depending on the movement path of the gripper robot (110). Furthermore, the collision avoidance setting unit (320) may count the number of times the gripper robot (110) moves through each unit area. That is, the collision avoidance setting unit (320) may count the number of times the gripper robot (110) passes through each of the multiple unit areas. Subsequently, the collision avoidance setting unit (320) may assign risk levels to each of the multiple unit areas based on the counted number of movements. For example, the collision avoidance setting unit (320) may classify the risk levels as high, medium, and low, and assign a higher risk level to unit areas with a higher number of movements. Additionally, the collision avoidance setting unit (320) may set the monitoring area to correspond with the generated path map, and may control the projection of light from the projector (120) to display different colors for each of the multiple unit areas according to the assigned risk levels. For example, as shown in FIG. 7, the collision avoidance setting unit (320) may display the unit area with a “high” risk level in brown, the unit area with a “medium” risk level in yellow, and the unit area with a “low” risk level in gray.

In another embodiment, the collision avoidance setting unit (320) may record the established work plan as a timestamp, and based on the recorded timestamp, may divide the work plan into preset sections. The collision avoidance setting unit (320) may variably set the monitoring area based on the estimated movement range of the gripper robot (110) for each of the divided sections. That is, the collision avoidance setting unit (320) may set different monitoring areas for the same task based on time, thereby ensuring safety while supporting more efficient operations.

In another embodiment, the collision avoidance setting unit (320) may control the projector (220) installed on the gripper robot (110) to move with the gripper robot (110) and project light toward the ground. This ensures that the projector (220) can project light onto the ground without any obstruction from the gripper robot (110). When the projector (220) is installed on the gripper robot (110), it moves with the gripper robot (110), so if the same light is projected, the monitoring area may shift according to the movement of the projector (220). Therefore, the collision avoidance setting unit (320) may variably control the light emitted from the projector (220) to ensure that the position of the monitoring area projected on the ground does not change, based on the movement of the gripper robot (110). For example, the collision avoidance setting unit (320) may predict the movement of the gripper robot (110) based on its kinematics information, and may variably control the direction or shape of the light emitted from the projector (220) to maintain the monitoring area in a fixed position on the ground, according to the predicted movement.

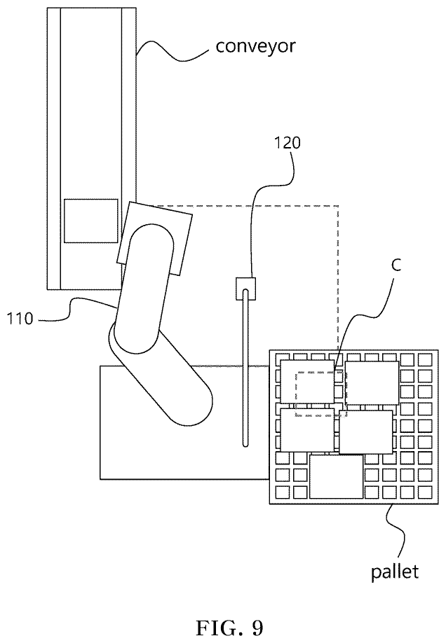

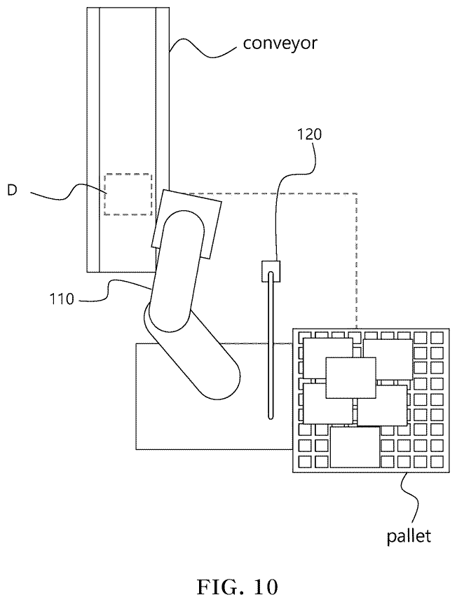

For a moment, referring to FIGS. 9 and 10, the collaborative function according to an embodiment of the present invention will be described in detail.

FIGS. 9 and 10 are illustrative diagrams for explaining the collaborative function according to an embodiment of the present invention.

Referring to FIGS. 9 and 10, the collaborative control unit (325) may guide the stacking location of the object gripped by the gripper robot (110) through the projector (110).

Specifically, the collaborative control unit (325) may identify the stacking location of the object gripped by the gripper robot (110) based on the work plan established for the task robot (110) and may display the expected stacking area in real-time at the identified stacking location through the projector (110). For example, as shown in FIG. 9, the collaborative control unit (325) may display the expected stacking area (C) in real-time for the gripper robot (110) to grip the object supplied from the conveyor and load it onto a pallet. Alternatively, as shown in FIG. 10, the collaborative control unit (325) may display the expected stacking area (D) in real-time for the gripper robot (110) to grip the object loaded onto the pallet and place it onto the conveyor.

In a subsequent configuration, the storage unit (330) may store data required for the operation of the management device (300).

Specifically, the storage unit (330) may store programs for establishing a work plan for the gripper robot (110), setting the movement path of the gripper robot (110) according to the work plan, or preventing collisions between the gripper robot (110) and the worker.

Hereinafter, the hardware for implementing the logical components of the management device (300) as described above will be explained in more detail.

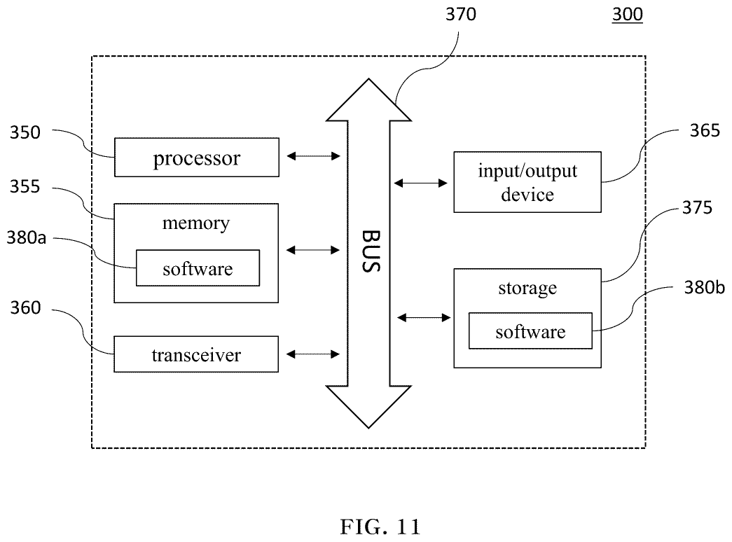

FIG. 11 is a hardware block diagram of a management device according to an embodiment of the present invention.

As shown in FIG. 11, the management device (300) may include a processor (350), a memory (355), a transceiver (360), an input/output device (365), a data bus (370), and a storage (375).

Specifically, the processor (350) may implement the operations and functions of the management device (300) based on instructions from the software (380a) implementing the logistics automation method, which is resident in the memory (355).

The memory (355) may load the software (380b) implementing the logistics automation method stored in the storage (375).

The input/output device (365) may receive signals required for the operation of the management device (300) or output computation results externally, according to commands from the processor (350).

The data bus (370) may be connected to the processor (350), memory (355), transceiver (360), input/output device (365), and storage (375), and may serve as a communication pathway to transmit signals between the respective components.

The storage (375) may store application programming interfaces (APIs), library files, resource files, and the like, which are necessary for executing the software (380a) that implements the logistics automation method according to the embodiments of the present invention. The storage (375) may also store the software (380b) that implements the logistics automation method according to the embodiments of the present invention.

According to an embodiment of the present invention, the software (380a, 380b) for implementing the logistics automation method, which is loaded in the memory (355) or stored in the storage (375), may be a computer program recorded on a recording medium to execute the following steps: estimating the movement of a gripper robot for gripping objects by the processor (350), variably setting a monitoring area with collision risks according to the movement of the gripper robot by the processor (350), and controlling the operation of the gripper robot by the processor (350) to display the set monitoring area through the projector.

More specifically, the processor (350) may include, but is not limited to, one or more of a Central Processing Unit (CPU), an Application-Specific Integrated Circuit (ASIC), a chipset, or a logic circuit.

The memory (355) may include, but is not limited to, one or more of a Read-Only Memory (ROM), a Random Access Memory (RAM), flash memory, or a memory card.

The input/output device (360) may include, but is not limited to, one or more input devices such as buttons, switches, a keyboard, a mouse, and a joystick, and one or more output devices such as a Liquid Crystal Display (LCD), a Light Emitting Diode (LED), an Organic Light Emitting Diode (OLED), an Active Matrix OLED (AMOLED), a printer, and a plotter.

When the embodiments described in this specification are implemented in software, the methods described above may be implemented as modules (procedures, functions, etc.) that each perform the respective functions. Each module may reside in the memory (355) and be executed by the processor (350). The memory (355) may be located either inside or outside the processor (350) and may be connected to the processor (350) by various well-known means.

Each component shown in FIG. 11 may be implemented by various means, such as hardware, firmware, software, or a combination thereof. When implemented in hardware, an embodiment of the present invention may be implemented using one or more of an Application-Specific Integrated Circuit (ASIC), a Digital Signal Processor (DSP), a Digital Signal Processing Device (DSPD), a Programmable Logic Device (PLD), a Field Programmable Gate Array (FPGA), a processor, a controller, a microcontroller, or a microprocessor.

Additionally, when implemented in firmware or software, an embodiment of the present invention may be implemented in the form of modules, procedures, or functions that perform the functions or operations described above, and may be recorded on a computer-readable recording medium via various computer means. The recording medium may include program instructions, data files, data structures, or any combination thereof.

The program instructions recorded on the recording medium may be specifically designed and configured for the present invention or may be known and available to those skilled in the art of computer software. For example, the recording medium may include magnetic media such as hard disks, floppy disks, and magnetic tapes; optical media such as CD-ROMs (Compact Disc Read Only Memory) and DVDs (Digital Video Discs); magneto-optical media such as floptical disks; and hardware devices specially configured to store and execute program instructions, such as ROM (Read-Only Memory), RAM (Random Access Memory), flash memory, and the like.

Examples of program instructions may include not only machine code generated by a compiler but also high-level language code that can be executed by a computer using an interpreter or the like. Such hardware devices may be configured to operate as one or more pieces of software to perform the operations of the present invention, and vice versa.

Hereinafter, the logistics automation method according to an embodiment of the present invention will be described.

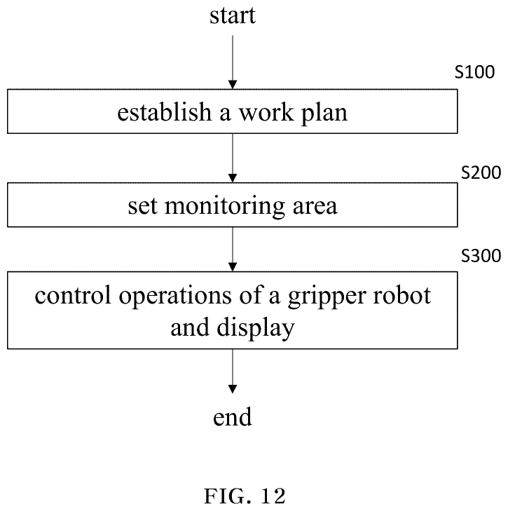

FIG. 12 is a flowchart for explaining a logistics automation method according to an embodiment of the present invention.

Referring to FIG. 12, in step S100, the management device may establish a work plan for the gripper robot. Specifically, the management device may establish a work plan for the gripper robot to grip an object loaded onto a pallet and transfer it to a conveyor, or to load an object from the conveyor onto the pallet.

Next, in step S200, the management device may set the monitoring area based on the movement range of the gripper robot established in step S100.

In one embodiment, the management device may estimate the movement range of the gripper robot based on the previously established work plan, and may variably set the monitoring area for each task based on the estimated movement range. Here, the movement range of the gripper robot may refer to the area affected by the actions of the gripper robot.

In another embodiment, the management device may simulate the movement of the gripper robot based on the established work plan. That is, the management device may generate a virtual robot corresponding to the gripper robot in a virtual space and simulate the movement of the gripper robot. The management device may then generate a path map by overlapping the movement paths of the gripper robot through the simulation. Furthermore, the management device may set the monitoring area based on the edge of the area corresponding to the gripper robot on the path map.

In another embodiment, the management device may divide the previously generated path map into multiple unit areas of a preset size. Subsequently, the management device may divide the generated path map into multiple unit areas. The management device may then count the number of movements of the gripper robot in each of the multiple unit areas. Following this, the management device may assign risk levels to each of the unit areas based on the counted number of movements. The management device may set the monitoring area to correspond with the generated path map. In this case, the management device may configure the system to output light from the projector in different colors for each of the multiple unit areas based on the assigned risk levels.

In another embodiment, the management device may record the established work plan as a timestamp, and based on the recorded timestamp, may divide the work plan into preset sections. The management device may then variably set the monitoring area based on the estimated movement range of the gripper robot for each of the divided sections.

In another embodiment, the management device may variably control the light emitted from the projector to ensure that the position of the monitoring area output on the ground does not change according to the movement of the gripper robot.

Then, in step S300, the management device may control the operation of the gripper robot, ensuring that the set monitoring area is displayed through the projector.

In this case, the management device may identify the stacking location of the object gripped by the gripper robot based on the work plan established for the task robot, and may display the expected stacking area in real-time at the identified stacking location through the projector.

As described above, although preferred embodiments of the present invention have been disclosed in this specification and the accompanying drawings, it will be apparent to those skilled in the art that various modifications based on the technical spirit of the present invention are possible in addition to the embodiments disclosed herein. Furthermore, while specific terms have been used in this specification and the drawings, these terms are used solely for the purpose of explaining the technical contents of the invention and aiding in the understanding of the invention, and are not intended to limit the scope of the invention. Therefore, the detailed description provided above should not be interpreted in a limiting manner, but rather should be considered as exemplary. The scope of the invention should be determined by a reasonable interpretation of the appended claims, and any modifications within the equivalent scope of the invention are included within the scope of the invention.

What is claimed is:

1. A logistics automation device with a collision avoidance function comprising:
a gripper robot gripping an object;
a projector displaying a monitoring area with collision risks based on the movement of the gripper robot; and
a controller controlling an operation of the gripper robot and an operation of the projector,
wherein the controller is configured to:
set the monitoring area dynamically according to the movement of the gripper robot, and
display the monitoring area through the projector.

2. The logistics automation device with the collision avoidance function of claim 1, wherein the projector is installed on the gripper robot, and
wherein the controller is configured to:
display the monitoring area on ground through the projector while the projector moves with the gripper robot.

3. The logistics automation device with the collision avoidance function of claim 2, wherein the controller is configured to:
control the light emitted from the projector dynamically according to the movement of the gripper robot to ensure that a position of the displayed monitoring area on the ground does not change.

4. The logistics automation device with the collision avoidance function of claim 1, wherein the controller is configured to:
establish a work plan for the gripper robot,
estimate a movement range of the gripper robot according to the work plan, and
set the monitoring area for each task dynamically based on the movement range.

5. The logistics automation device with the collision avoidance function of claim 4, wherein the controller is configured to:
generate a path map in which movement paths of the gripper robot are overlapped, by simulating the movement of the gripper robot based on the work plan,
set the monitoring area to correspond with the path map, and
display the monitoring area through the projector.

6. The logistics automation device with the collision avoidance function of claim 5, wherein the controller is configured to:
divide the path map into multiple unit areas of preset size,
count a number of movements of the gripper robot in each of the multiple unit areas, and
assign risk level to each of the multiple unit areas based on the counted number of the movement of the gripper robot.

7. The logistics automation device with the collision avoidance function of claim 6, wherein the controller is configured to:
set the monitoring area to correspond with the path map, and
control the light emitted from the projector in different colors for each of the multiple unit areas according to the risk level.

8. The logistics automation device with the collision avoidance function of claim 4, wherein the controller is configured to:
identify stacking location of the object gripped by the gripper robot based on the work plan, and
display expected stacking area in real-time at the stacking location through the projector.

9. The logistics automation device with the collision avoidance function of claim 4, wherein the controller is configured to:
record the work plan as a timestamp,
divide the work plan into preset sections based on the timestamp, and
set the monitoring area dynamically based on the estimated movement range of the gripper robot for each of the divided sections.

10. A logistics automation method comprising:
setting monitoring area dynamically according to movement of gripper robot; and
displaying the monitoring area through a projector;
wherein the gripper robot grips an object,
wherein the monitoring area is displayed with collision risks based on the movement of the gripper robot through the projector.
